(19) United States
(12) Patent Application Publication
(10) Pub. No.: US 2025/0247894 A1
(43) Pub. Date: Jul. 31, 2025

(54) RANDOM ACCESS BASED LOWER LAYER TRIGGERED MOBILITY

(71) Applicant: Samsung Electronics Co., Ltd., Suwon-si (KR)

(72) Inventor: Anil Agiwal, McKinney, TX (US)

(21) Appl. No.: 19/017,366

(22) Filed: Jan. 10, 2025

Related U.S. Application Data
(60) Provisional application No. 63/625,065, filed on Jan. 25, 2024.

(51) Int. Cl. H04W 74/0833; H04W 36/00; H04W 72/21

(52) U.S. Cl. CPC H04W 74/0833; H04W 36/0077; H04W 72/21

(57) ABSTRACT

A method of operating a UE includes receiving, from a source cell, an RRC reconfiguration message including a LTM candidate configuration of one or more LTM candidate cells, and receiving, from the source cell, an LTM cell switch command to switch to a target cell amongst the one or more LTM candidate cells. The LTM cell switch command includes a first field indicating one of a SUL carrier and an NUL carrier for PRACH transmission, and a second field indicating a PRACH Mask index. The method also includes determining whether the LTM candidate configuration of the target cell includes a dedicated RACH configuration for the UL carrier indicated by the first field in the LTM cell switch command, and determining, based on whether the LTM candidate configuration of the target cell includes the dedicated RACH configuration, a subset of RACH occasion(s) for a PRACH transmission to the target cell.

### CROSS-REFERENCE TO RELATED APPLICATION(S) AND CLAIM OF PRIORITY

This application claims priority under 35 U.S.C. § 119 (e) to U.S. Provisional Patent Application No. 63/625,065 filed on Jan. 25, 2024. The above-identified provisional patent application is hereby incorporated by reference in its entirety.

### TECHNICAL FIELD

This disclosure relates generally to wireless networks. More specifically, this disclosure relates to random access (RA) based lower layer triggered mobility (LTM).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for RA based LTM.

In one embodiment, a user equipment (UE) is provided. The UE includes a transceiver, and a processor operatively coupled to the transceiver. The transceiver is configured to receive, from a source cell, a radio resource control (RRC) reconfiguration message including a lower layer triggered mobility (LTM) candidate configuration of one or more LTM candidate cells. The transceiver is also configured to receive, from the source cell, an LTM cell switch command to switch to a target cell amongst the one or more LTM candidate cells. The LTM cell switch command includes a first field indicating one of a supplementary uplink (SUL) carrier and a normal uplink (NUL) carrier for physical random access channel (PRACH) transmission, and a second field indicating a PRACH Mask index. The processor is configured to determine whether the LTM candidate configuration of the target cell includes a dedicated random access channel (RACH) configuration for the uplink (UL) carrier indicated by the first field in the LTM cell switch command, and determine, based on whether the LTM candidate configuration of the target cell includes the dedicated RACH configuration, a subset of RACH occasion(s) for a PRACH transmission to the target cell.

In another embodiment, a base station (BS) is provided. The BS includes a processor, and a transceiver operatively coupled to the processor. The transceiver is configured to transmit, to a UE, a RRC reconfiguration message including a LTM candidate configuration of one or more LTM candidate cells, and transmit, to the UE, an LTM cell switch command to switch to a target cell amongst the one or more LTM candidate cells. The LTM cell switch command includes a first field indicating one of a SUL carrier and a NUL carrier for PRACH transmission, and a second field indicating a PRACH Mask index.

In yet another embodiment, a method of operating a UE is provided. The method includes receiving, from a source cell, an RRC reconfiguration message including a LTM candidate configuration of one or more LTM candidate cells, and receiving, from the source cell, an LTM cell switch command to switch to a target cell amongst the one or more LTM candidate cells. The LTM cell switch command includes a first field indicating one of a SUL carrier and an NUL carrier for PRACH transmission, and a second field indicating a PRACH Mask index. The method also includes determining whether the LTM candidate configuration of the target cell includes a dedicated RACH configuration for the UL carrier indicated by the first field in the LTM cell switch command, and determining, based on whether the LTM candidate configuration of the target cell includes the dedicated RACH configuration, a subset of RACH occasion(s) for a PRACH transmission to the target cell.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example procedure for LTM according to embodiments of the present disclosure;

FIG. 5 illustrates an example procedure for lower layer triggered mobility according to embodiments of the present disclosure;

FIG. 6 illustrates an example method for RA based LTM according to embodiments of the present disclosure; and

FIG. 7 illustrates another example method for RA based LTM according to embodiments of the present disclosure.

### DETAILED DESCRIPTION

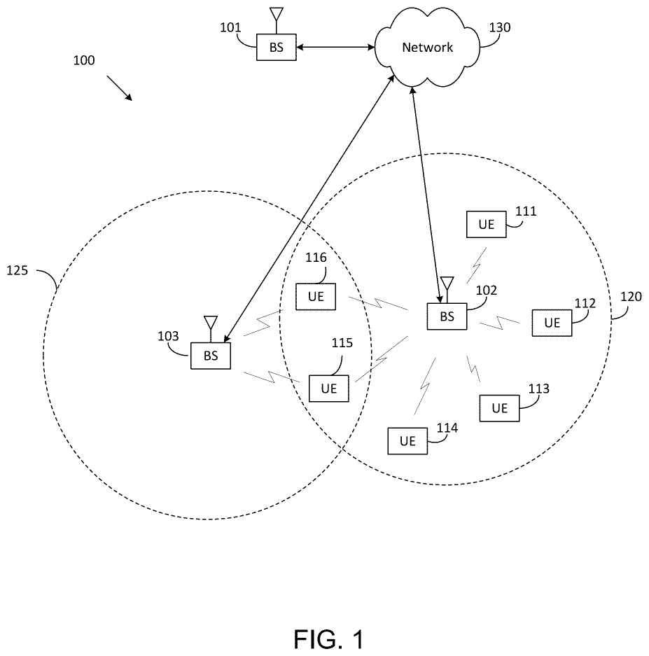

FIGS. 1 through 7, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for RA based LTM. In certain embodiments, one or more of the gNBs 101-103 includes circuitry, programing, or a combination thereof, to support RA based LTM in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

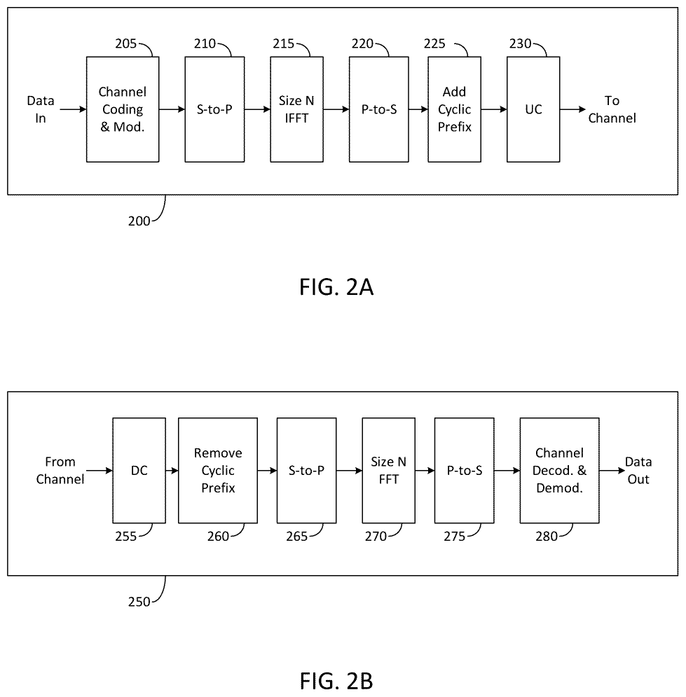

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support RA based LTM as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

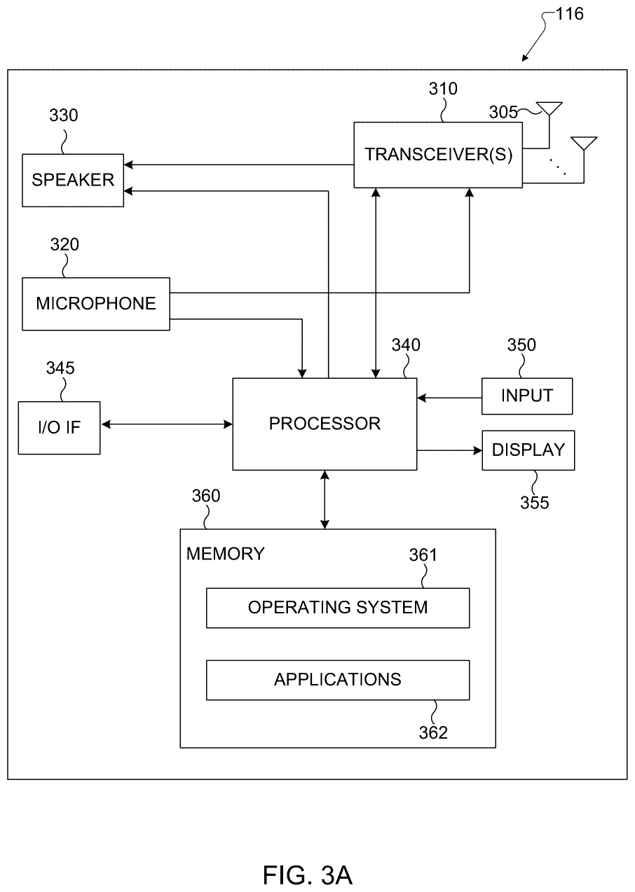

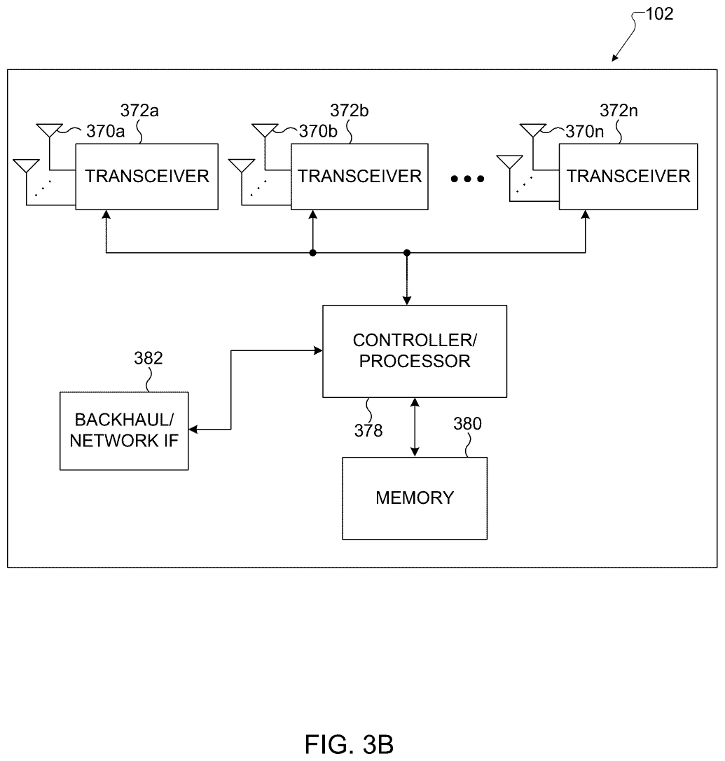

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for RA based LTM as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support RA based LTM as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

In the next generation wireless communication system (e.g., 5G, beyond 5G, 6G) operating in higher frequency (mmWave) bands, UEs and gNBs may communicate with each other using Beamforming. Beamforming techniques are used to mitigate propagation path losses and to increase propagation distance for communication at higher frequency bands. Beamforming enhances transmission and reception performance using a high-gain antenna. Beamforming can be classified into Transmission (TX) beamforming performed in a transmitting end and reception (RX) beamforming performed in a receiving end. In general, TX beamforming increases directivity by allowing an area in which propagation reaches to be densely located in a specific direction by using a plurality of antennas. In this situation, aggregation of the plurality of antennas can be referred to as an antenna array, and each antenna included in the array can be referred to as an array element. The antenna array can be configured in various forms such as a linear array, a planar array, etc. The use of TX beamforming results in an increase in the directivity of a signal, thereby increasing the propagation distance. Further, since the signal is almost not transmitted in a direction other than a directivity direction, a signal interference acting on another receiving end is significantly decreased. The receiving end can perform beamforming on a RX signal by using a RX antenna array. RX beamforming increases the RX signal strength transmitted in a specific direction by allowing propagation to be concentrated in a specific direction and excludes a signal transmitted in a direction other than the specific direction from the RX signal, thereby providing an effect of blocking an interference signal. By using beamforming techniques, a transmitter can generate a plurality of transmit beam patterns of different directions. Each of these transmit beam patterns can also be referred to as a transmit (TX) beam. Wireless communication systems operating at high frequency may use a plurality of narrow TX beams to transmit signals in the cell as each narrow TX beam provides coverage to a part of cell. The narrower the TX beam, the higher the antenna gain and hence a larger propagation distance of a signal transmitted using beamforming. A receiver can also generate plurality of receive (RX) beam patterns of different directions. Each of these receive patterns can be also referred to as a receive (RX) beam.

The next generation wireless communication system (e.g., 5G, beyond 5G, 6G) supports a standalone mode of operation as well dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in an RRC_CONNECTED state is configured to utilize radio resources provided by two distinct schedulers, located in two different nodes connected via a non-ideal backhaul and providing either E-UTRA (i.e., if the node is an ng-eNB) or NR access (i.e., if the node is a gNB). In NR for a UE in an RRC_CONNECTED state not configured with carrier aggregation (CA)/DC there is only one serving cell comprising the primary cell. For a UE in an RRC_CONNECTED state configured with CA/DC the term ‘serving cells’ is used to denote the set of cells comprising the Special Cell(s) and all secondary cells. In NR the term Master Cell Group (MCG) refers to a group of serving cells associated with the Master Node, comprising the Primary Cell (PCell) and optionally one or more secondary cells (SCells). In NR the term Secondary Cell Group (SCG) refers to a group of serving cells associated with the Secondary Node, comprising the Primary SCG Cell (PSCell) and optionally one or more SCells. In NR, PCell refers to a serving cell in the MCG, operating on the primary frequency, in which the UE either performs the initial connection establishment procedure or initiates the connection re-establishment procedure. In NR for a UE configured with CA, an SCell is a cell providing additional radio resources on top of a Special Cell. PSCell refers to a serving cell in the SCG in which the UE performs random access when performing the Reconfiguration with Sync procedure. For Dual Connectivity operation, Special Cell (SpCell) refers to the PCell of the MCG or the PSCell of the SCG. Otherwise, the term Special Cell refers to the PCell.

In the next generation wireless communication system (e.g., 5G, beyond 5G, 6G), a node B (gNB) or base station in cell broadcast Synchronization Signal and PBCH (SS/PBCH) block (SSB), includes primary and secondary synchronization signals (PSS, SSS) and system information (SI). The SI includes common parameters needed to communicate in the cell. In the fifth generation wireless communication system (also referred as next generation radio or NR), SI is divided into the master information block (MIB) and a number of system information blocks (SIBs), wherein the MIB may be transmitted on the broadcast channel (BCH) with a periodicity of 80 ms and repetitions made within 80 ms and the MIB includes parameters that are needed to acquire SIB1 from the cell. The SIB1 is transmitted on the downlink shared channel (DL-SCH) with a periodicity of 160 ms and variable transmission repetition. The default transmission repetition periodicity of SIB1 is 20 ms but the actual transmission repetition periodicity is up to network implementation. For SSB and CORESET multiplexing pattern 1, the SIB1 repetition transmission period is 20 ms. For SSB and CORESET multiplexing pattern 2/3, the SIB1 transmission repetition period is the same as the SSB period. SIB1 includes information regarding the availability and scheduling (e.g., mapping of SIBs to SI message, periodicity, SI-window size) of other SIBs with an indication whether one or more SIBs are only provided on-demand and, in that case, the configuration needed by the UE to perform the SI request. SIB1 is a cell-specific SIB. SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with a same length for all SI messages). Each SI message is associated with an SI-window and the SI-windows of different SI messages do not overlap. That is to say, within one SI-window only the corresponding SI message is transmitted. An SI message may be transmitted a number of times within the SI-window. Any SIB or posSIB except SIB1 can be configured to be cell specific or area specific, using an indication in SIB1. A cell specific SIB is applicable only within a cell that provides the SIB while an area specific SIB is applicable within an area referred to as an SI area, which includes one or several cells and is identified by systemInformationArealD. The mapping of SIBs to SI messages is configured in schedulingInfoList, while the mapping of posSIBs to SI messages is configured in pos-SchedulingInfoList. Each SIB is contained only in a single SI message and each SIB and posSIB is contained at most once in that SI message. For a UE in an RRC CONNECTED state, the network can provide system information through dedicated signaling using the RR (Reconfiguration message, e.g., if the UE has an active BWP with no common search space configured to monitor system information, paging, or upon request from the UE. In an RRC_CONNECTED state, the UE acquires the required SIB(s) from the PCell. For the PSCell and SCells, the network provides the required SI by dedicated signaling, i.e., within an RRCReconfiguration message. Nevertheless, the UE shall acquire a MIB of the PSCell to get system frame number (SFN) timing of the SCG (which may be different from the MCG). Upon change of relevant SI for the SCell, the network releases and adds the concerned SCell. For the PSCell, the required SI can be changed with Reconfiguration with Sync.

In the next generation wireless communication system (e.g., 5G, beyond 5G, 6G), a Physical Downlink Control Channel (PDCCH) is used to schedule DL transmissions on a Physical Downlink Shared Channel (PDSCH) and UL transmissions on a Physical Uplink Shared Channel (PUSCH), where the Downlink Control Information (DCI) on the PDCCH includes: downlink assignments containing at least modulation and coding format, resource allocation, and hybrid-ARQ information related to DL-SCH; uplink scheduling grants containing at least modulation and coding format, resource allocation, and hybrid-ARQ information related to UL-SCH. In addition to scheduling, the PDCCH can be used to for: activation and deactivation of configured PUSCH transmission with configured grant; activation and deactivation of PDSCH semi-persistent transmission; notifying one or more UEs of the slot format; notifying one or more UEs of the PRB(s) and OFDM symbol(s) where the UE may assume no transmission is intended for the UE; transmission of TPC commands for the Physical Uplink Control Channel (PUCCH) and PUSCH; transmission of one or more TPC commands for SRS transmissions by one or more UEs; switching a UE's active bandwidth part (BWP); and initiating a random access procedure. A UE monitors a set of PDCCH candidates in the configured monitoring occasions in one or more configured COntrol REsource SETs (CORESETs) according to the corresponding search space configurations. A CORESET includes a set of PRBs with a time duration of 1 to 3 OFDM symbols. The resource units Resource Element Groups (REGs) and Control Channel Elements (CCEs) are defined within a CORESET with each CCE including a set of REGs. Control channels are formed by aggregation of CCEs. Different code rates for the control channels are realized by aggregating different numbers of CCEs. Interleaved and non-interleaved CCE-to-REG mappings are supported in a CORESET. Polar coding is used for the PDCCH. Each resource element group carrying the PDCCH carries its own DeModulation Reference Signal (DMRS). Quadrature Phase Shift Keying (QPSK) modulation is used for the PDCCH.

In the next generation wireless communication system (e.g., 5G, beyond 5G, 6G), a list of search space configurations is signaled by the gNB for each configured BWP of the serving cell, wherein each search configuration is uniquely identified by a search space identifier. The search space identifier is unique amongst the BWPs of a serving cell. An identifier of search space configuration to be used for specific purpose such as paging reception, SI reception, random access response reception, etc. is explicitly signaled by the gNB for each configured BWP. In NR, a search space configuration comprises the parameters Monitoring-periodicity-PDCCH-slot, Monitoring-offset-PDCCH-slot, Monitoring-symbols-PDCCH-within-slot and duration. A UE determines a PDCCH monitoring occasion(s) within a slot using the parameters PDCCH monitoring periodicity (Monitoring-periodicity-PDCCH-slot), the PDCCH monitoring offset (Monitoring-offset-PDCCH-slot), and the PDCCH monitoring pattern (Monitoring-symbols-PDCCH-within-slot). PDCCH monitoring occasions are in slots ‘x’ to x+duration, where the slot with number ‘x’ in a radio frame with number ‘y’ satisfies the equation below:

(y*(number of slots in a radio frame)+x−Monitoring-offset-PDCCH-slot)mod(Monitoring-periodicity-PDCCH-slot)=0.

The starting symbol of a PDCCH monitoring occasion in each slot having PDCCH monitoring occasion is given by the parameter Monitoring-symbols-PDCCH-within-slot. The length (in symbols) of a PDCCH monitoring occasion is given in the CORESET associated with the search space. A search space configuration includes the identifier of CORESET configuration associated with it. A list of CORESET configurations are signaled by the gNB for each configured BWP of the serving cell, wherein each CORESET configuration is uniquely identified by a CORESET identifier. The CORESET identifier is unique amongst the BWPs of a serving cell. Note that each radio frame is of 10 ms duration. A radio frame is identified by a radio frame number or system frame number. Each radio frame comprises several slots, wherein the number of slots in a radio frame and duration of slots depends on sub carrier spacing (SCS). The number of slots in a radio frame and duration of slots for each supported SCS is pre-defined in NR. Each CORESET configuration is associated with a list of TCI (Transmission configuration indicator) states. One DL RS ID (SSB or CSI RS) is configured per TCI state. The list of TCI states corresponding to a CORESET configuration is signaled by the gNB via RRC signaling. One of the TCI states in a TCI state list is activated and indicated to the UE by the gNB. The TCI state indicates the DL TX beam (DL TX beam is QCLed with an SSB/CSI RS of the TCI state) used by the gNB for transmission of the PDCCH in the PDCCH monitoring occasions of a search space.

In the next generation wireless communication system (e.g., 5G, beyond 5G, 6G) bandwidth adaptation (BA) is supported. With BA, the receive and transmit bandwidth of a UE need not be as large as the bandwidth of the cell and can be adjusted: the width can be ordered to change (e.g., to shrink during period of low activity to save power); the location can move in the frequency domain (e.g., to increase scheduling flexibility); and the subcarrier spacing can be ordered to change (e.g., to allow different services). A subset of the total cell bandwidth of a cell is referred to as a Bandwidth Part (BWP). BA is achieved by configuring an RRC connected UE with BWP(s) and telling the UE which of the configured BWPs is currently the active one. When BA is configured, the UE only has to monitor PDCCH on the one active BWP i.e., it does not have to monitor the PDCCH on the entire DL frequency of the serving cell. In an RRC connected state, the UE is configured with one or more DL and UL BWPs, for each configured Serving Cell (i.e., PCell or SCell). For an activated Serving Cell, there is one active UL and DL BWP at any point in time. BWP switching for a Serving Cell is used to activate an inactive BWP and deactivate an active BWP at a time. BWP switching is controlled by the PDCCH indicating a downlink assignment or an uplink grant, by the bwp-Inactivity Timer, by RRC signalling, or by the MAC entity itself upon initiation of a random-access procedure. Upon addition of a SpCell or activation of an SCell, the DL BWP and UL BWP indicated by firstActiveDownlinkBWP-Id and firstActiveUplinkBWP-Id respectively is active without receiving a PDCCH indicating a downlink assignment or an uplink grant. The active BWP for a Serving Cell is indicated by either RRC or the PDCCH. For unpaired spectrum, a DL BWP is paired with a UL BWP, and BWP switching is common for both UL and DL. Upon expiry of the BWP inactivity timer, the UE switches the active DL BWP to the default DL BWP or initial DL BWP (if a default DL BWP is not configured).

In the next generation wireless communication system (e.g., 5G, beyond 5G, 6G), random access (RA) is supported. RA is used to achieve uplink (UL) time synchronization. RA is used during initial access, handover, radio resource control (RRC) connection re-establishment procedure, scheduling request transmission, secondary cell group (SCG) addition/modification, beam failure recovery and data or control information transmission in UL by non-synchronized UEs in the RRC CONNECTED state. Several types of random access procedure are supported, such as 2 step and 4 step contention based random access (CBRA), as well as 2 step and 4 step and contention free random access (CFRA).

Layer 1 (L1)/layer 2 (L2) triggered mobility, also referred to herein as lower layer triggered mobility (LTM), is a procedure in which a gNB receives L1 measurement report(s) from a UE, and on the basis of the L1 measurement report(s) the gNB changes the UE's serving cell by a cell switch command signaled via a medium access control (MAC) control element (CE). The cell switch command indicates an LTM candidate cell configuration that the gNB previously prepared and provided to the UE through RRC signaling. Then the UE switches to the target cell according to the cell switch command. The LTM procedure can be used to reduce mobility latency. The network may request the UE to perform early timing advance (TA) acquisition of a candidate cell before a cell switch. The early TA acquisition is triggered by a PDCCH order or through a UE-based TA measurement.

The network indicates in the cell switch command whether the UE shall access the target cell with a random access (RA) procedure if a TA value is not provided or with a PUSCH transmission using the indicated TA value. For random access channel (RACH) less LTM, the UE accesses the target cell via the configured grant (CG) provided in the RRC signaling and selects the CG occasion associated with the beam indicated in the cell switch command. The UE may monitor the PDCCH for dynamic scheduling from the target cell upon an LTM cell switch.

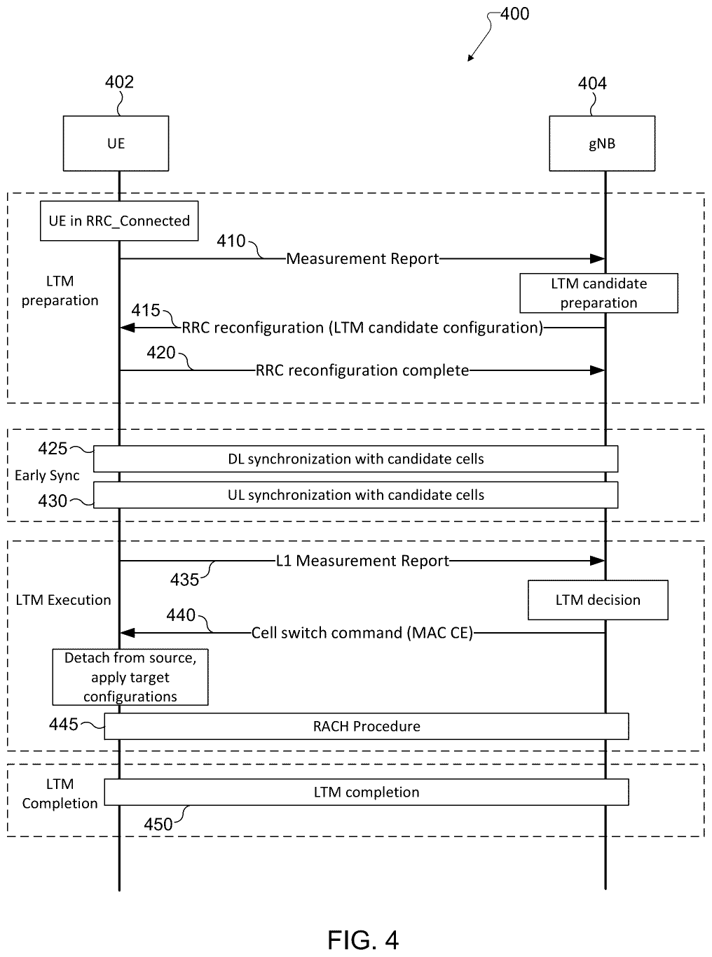

FIG. 4 illustrates an example procedure for LTM 400 according to embodiments of the present disclosure. An embodiment of the method illustrated in FIG. 4 is for illustration only. One or more of the components illustrated in FIG. 4 may be implemented in specialized circuitry configured to perform the noted functions or one or more of the components may be implemented by one or more processors executing instructions to perform the noted functions. Other embodiments of a procedure for LTM could be used without departing from the scope of this disclosure.

In the example of FIG. 4, procedure 400 begins at step 410. At step 410, UE 402, which is in an RRC connected state sends a MeasurementReport message to gNB 404. gNB 404 then decides to configure LTM and initiates candidate cell(s) preparation.

At step 415, gNB 404 transmits an RRCReconfiguration message to UE 402 including the LTM candidate cell configurations of one or multiple candidate cells.

At step 420, UE 402 stores the LTM candidate cell configurations and transmits an RRCReconfigurationComplete message to gNB 404.

At step 425, UE 402 may perform DL synchronization with candidate cell(s) before receiving a cell switch command.

At step 430, if requested by the network, UE 402 performs early TA acquisition with candidate cell(s) before receiving the cell switch command. This is done via contention free random access (CFRA) triggered by a PDCCH order from the source cell, following which UE 402 sends a preamble towards the indicated candidate cell. In order to minimize the data interruption of the source cell due to the CFRA towards the candidate cell(s), UE 402 doesn't receive a RAR for the purpose of TA value acquisition and the TA value of the candidate cell is indicated in the cell switch command. UE 402 doesn't maintain the TA timer for the candidate cell and relies on network implementation to guarantee the TA validity.

At step 435, UE 402 performs L1 measurements on the configured candidate cell(s) and transmits L1 measurement reports to the gNB.

At step 440, gNB 404 decides to execute cell switch to a target cell and transmits a MAC CE triggering cell switch by including the candidate configuration index of the target cell. UE 402 switches to the target cell and applies the configuration indicated by the candidate configuration index.

At step 445, UE 402 performs a random access procedure towards the target cell if UE does not have valid TA of the target cell.

At step 450, UE 402 completes the LTM cell switch procedure by sending a RRCReconfigurationComplete message to the target cell. If UE 402 has performed a RA procedure in step 7, UE 402 considers that the LTM execution is successfully completed when the random access procedure is successfully completed. For RACH-less LTM, UE 402 considers that the LTM execution is successfully completed when the UE determines that the network has successfully received its first UL data. UE 402 determines successful reception of its first UL data by receiving a PDCCH addressing UE 402's C-RNTI in the target cell, which schedules a new transmission following the first UL data.

Although FIG. 4 illustrates one example procedure for LTM 400, various changes may be made to FIG. 4. For example, while shown as a series of steps, various steps in FIG. 4 could overlap, occur in parallel, occur in a different order, occur any number of times, be omitted, or replaced by other steps.

In some embodiments, a cell switch command (e.g., an LTM cell switch command MAC CE) may include a field ‘C’. The length of the C field is 1 bit. The C field indicates the presence of contention-free Random Access Resources fields. If the value of the C field is set to 1, the following fields are present, including Random Access Preamble index field, S/U field, SS/PBCH index field and PRACH Mask index field.

In some embodiments, a cell switch command (e.g., an LTM cell switch command MAC CE) may include a field ‘S/U’ which indicates which UL carrier to transmit the PRACH of contention-free Random Access Resources. If the value of the S/U field is set to 1, the supplementary uplink (SUL) carrier is used; otherwise, the normal uplink (NUL) carrier is used. The length of the S/U field is 1 bit.

In some embodiments, a cell switch command (e.g., an LTM cell switch command MAC CE) may include a Random Access Preamble index field which indicates the Random Access Preamble index of contention-free Random Access Resources. The length of the Random Access Preamble index field is 6 bits.

In some embodiments, a cell switch command (e.g., an LTM cell switch command MAC CE) may include an SS/PBCH index field which indicates the SS/PBCH that shall be used to determine the RACH occasion for the PRACH transmission of contention-free Random Access Resources.

In some embodiments, a cell switch command (e.g., an LTM cell switch command MAC CE) may include a PRACH Mask index. A PRACH Mask index is used to determine a RACH occasion for transmitting a contention free preamble to a target cell.

In some embodiments, RACH occasions are configured by the field prach-ConfigurationIndex. The number of PRACH occasions in a PRACH configuration period is pre-defined for each PRACH configuration index. The PRACH configuration period for each PRACH configuration index is also pre-defined. A pre-defined PRACH configuration table lists a number of configurations, wherein each configuration indicates a number of PRACH occasions in the PRACH configuration period, the PRACH configuration period, and the location in time of the PRACH occasions in the PRACH configuration period. A PRACH configuration index is an index to an entry in this PRACH configuration table.

In some embodiments, The RACH occasions configured by the field prach-ConfigurationIndex are associated/mapped to SSBs transmitted in the cell per association period. Multiple RACH occasions can be associated with or mapped to an SSB. Based on ssb-perRACH-Occasion and the number of SSBs transmitted in cell, the PRACH occasions configured by prach-ConfigurationIndex are mapped to SSBs. The PRACH occasions are mapped to the SSBs over an association period. The association period, starting from SFN 0, is the period in which all SSBs are mapped to PRACH occasions at least once.

The PRACH Mask index indicates which of the RACH occasions associated with the SS/PBCH indicated by “SS/PBCH index” are used for PRACH transmission using the contention-free Random Access Resources received in the LTM cell switch command MAC CE.

During an LTM cell switch, a target cell is the cell to which the UE switches upon receiving an LTM cell switch command MAC CE. The target cell is indicated in the LTM cell switch command MAC CE. However, prach-ConfigurationIndex for a target cell is not signaled in an LTM cell switch command MAC CE. Several different prach-ConfigurationIndex configurations for a target cell can be received by the UE in a RRCReconfiguration message for the target cell (i.e., in step 415 of FIG. 4) as explained below:

The RRCReconfiguration message for the target cell may include a rach-ConfigDedicated IE for an SUL carrier. The rach-ConfigDedicated IE for the SUL carrier may include a rach-ConfigGeneric IE. This rach-ConfigGeneric IE includes a prach-ConfigurationIndex configuration.

The RRCReconfiguration message for the target cell may include a rach-ConfigDedicated IE for a NUL carrier. The rach-ConfigDedicated for the NUL carrier may include a rach-ConfigGeneric IE. This rach-ConfigGeneric IE includes a prach-ConfigurationIndex configuration.

The RRCReconfiguration message for the target cell may include a rach-ConfigCommon IE in the UL BWP configuration of the SUL carrier. The UL BWP configuration of one or more UL BWPs is received in the RRCReconfiguration message for target cell. The rach-ConfigCommon IE includes a rach-ConfigGeneric IE. This rach-ConfigGeneric IE includes a prach-ConfigurationIndex configuration. In the case where there are ‘N’ (where N is >=1) UL BWPs on the SUL carrier, there can be N different prach-ConfigurationIndex configurations in the RRCReconfiguration message for the SUL carrier of the target cell.

The RRCReconfiguration message for target cell may include a rach-ConfigCommon IE in the UL BWP configuration of the NUL carrier. The UL BWP configuration of one or more UL BWPs is received in the RRCReconfiguration message for target cell. The rach-ConfigCommon IE includes a rach-ConfigGeneric IE. This rach-ConfigGeneric IE includes a prach-ConfigurationIndex. In the case where there are ‘N’ (where N is >=1) UL BWPs on the NUL carrier, there can be N different prach-ConfigurationIndex configurations in the RRCReconfiguration message for the NUL carrier of target cell.

In the above situation, with several different prach-ConfigurationIndex configurations available for the target cell, the UE does not know which prach-ConfigurationIndex configuration is used to determine RACH occasions for transmitting the contention free random access preamble received in the LTM cell switch command MAC CE to the target cell. To overcome this issue, various embodiments of the present disclosure provide a mechanism for the UE to select a particular prach-ConfigurationIndex configuration when several prach-ConfigurationIndex configurations are available and apply the PRACH Mask index received in the LTM cell switch command MAC CE to RACH occasions configured by the selected prach-ConfigurationIndex configuration to determine a RACH occasion for transmitting a random access preamble to the target cell.

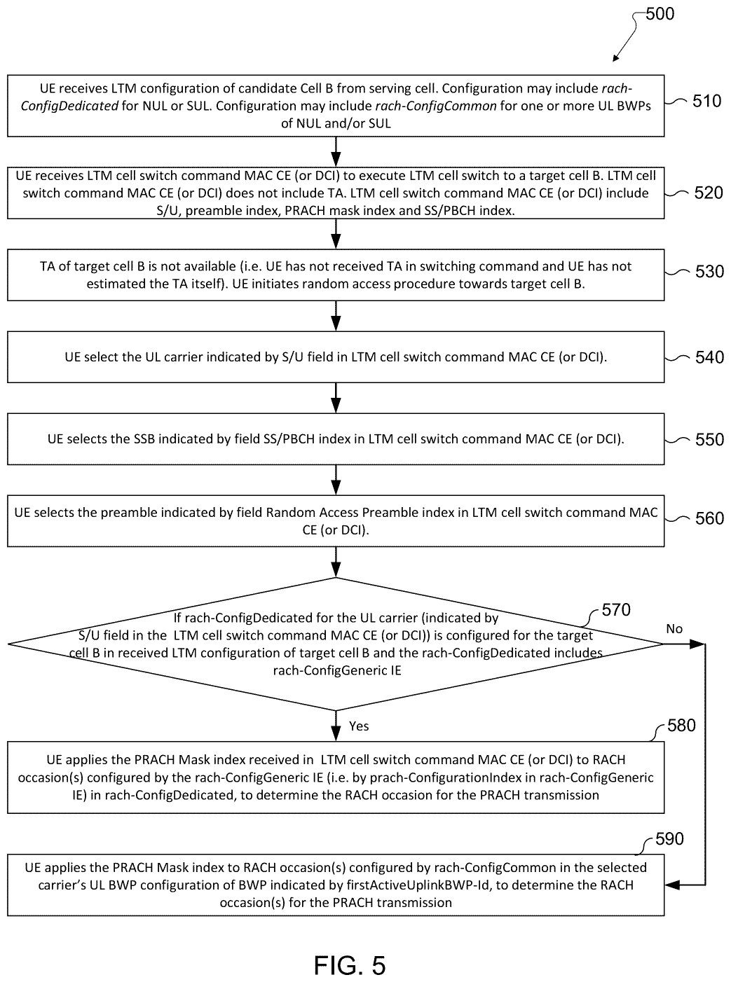

FIG. 5 illustrates an example procedure for lower layer triggered mobility 500 according to embodiments of the present disclosure. An embodiment of the procedure illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. Other embodiments of a procedure for lower layer triggered mobility could be used without departing from the scope of this disclosure.

In the example of FIG. 5, procedure 500 begins at step 510. At step 510, a gNB or base station (such as BS 102 of FIG. 1) of a Cell “A” provides an LTM configuration of a candidate cell “B” to a UE (such as UE 116 of FIG. 1). Cell A is the serving cell of the UE.

The LTM configuration of candidate Cell B includes a configuration of Cell B to be applied in case an LTM cell switch procedure is executed to Cell B. This configuration can be signaled by including an RRCReconfiguration IE for candidate Cell B in the LTM configuration.

In some embodiments, the RRCReconfiguration IE for candidate Cell B may include a rach-ConfigDedicated IE for a SUL carrier. The rach-ConfigDedicated IE for the SUL carrier may include a rach-ConfigGeneric IE. This rach-ConfigGeneric IE includes a prach-ConfigurationIndex configuration. prach-ConfigurationIndex indicates RACH occasions.

In some embodiments, the RRCReconfiguration IE for candidate Cell B may include a rach-ConfigDedicated IE for a NUL carrier. The rach-ConfigDedicated IE for the NUL carrier may include a rach-ConfigGeneric IE. This rach-ConfigGeneric IE includes a prach-ConfigurationIndex configuration. prach-ConfigurationIndex indicates RACH occasions.

In some embodiments, the RRCReconfiguration IE for candidate Cell B may include a rach-ConfigCommon IE in the UL BWP configuration of the SUL carrier. The UL BWP configuration of one or more UL BWPs is received in the RRCReconfiguration IE for candidate Cell B. The rach-ConfigCommon IE includes a rach-ConfigGeneric IE. The rach-ConfigGeneric IE includes a prach-ConfigurationIndex configuration. In cases where there are ‘N’ (where N is >=1) UL BWPs on the SUL carrier, there can be N different prach-ConfigurationIndex configurations for the SUL carrier of candidate Cell B in the RRCReconfiguration IE. Note that there can be several rach-ConfigCommon IEs in the UL BWP configuration of the SUL carrier, each associated with a different feature/feature combination. For example, the feature can be SDT, redcap, slicing, Msg3 repetitions, Msg1 repetitions etc. In these embodiments, the rach-ConfigCommon IE referred to is the rach-ConfigCommon IE which is not associated with any feature/feature combination if the UE is not a reduced capability (redcap) UE. For a redcap UE, the rach-ConfigCommon IE is the rach-ConfigCommon IE which is associated with redcap only or the rach-ConfigCommon IE is the rach-ConfigCommon IE which is not associated with any feature/feature combination if there is no rach-ConfigCommon IE associated with redcap only.

In some embodiments, the RRCReconfiguration IE for candidate Cell B may include a rach-ConfigCommon IE in the UL BWP configuration of the NUL carrier. The UL BWP configuration of one or more UL BWPs is received in the RRCReconfiguration IE for candidate Cell B. The rach-ConfigCommon IE includes a rach-ConfigGeneric IE. The rach-ConfigGeneric IE includes a prach-ConfigurationIndex configuration. In cases where there are ‘N’ (where N is >=1) UL BWPs on the NUL carrier, there can be N different prach-ConfigurationIndex configurations for the NUL carrier of candidate Cell B in the RRCReconfiguration IE. Note that there can be several rach-ConfigCommon IEs in the UL BWP configuration of the NUL carrier, each associated with different feature/feature combination. For example, the feature can be SDT, redcap, slicing, Msg3 repetitions, Msg1 repetitions etc. In these embodiments, the rach-ConfigCommon IE referred to is the rach-ConfigCommon IE which is not associated with any feature/feature combination if UE is not a redcap UE. For a redcap UE, the rach-ConfigCommon IE is the rach-ConfigCommon IE which is associated with redcap only or the rach-ConfigCommon IE is the rach-ConfigCommon IE which is not associated with any feature/feature combination if there is no rach-ConfigCommon IE associated with redcap only.

In cases where Cell A and Cell B belong to different distributed units (DUs) of the same gNB, the gNB or base station may obtain the configuration of Cell B from the DU of Cell B. In cases where Cell A and Cell B belong to different DUs of different gNBs, the gNB or base station or centralized unit (CU) of Cell A may obtain the configuration of Cell B from the gNB or base station or CU of Cell B.

The LTM configuration of candidate Cell B may include an L1 measurement configuration.

The UE confirms the RRC Reconfiguration by transmitting an RRCReconfiguration complete message. (not shown).

The UE provides an L1 measurement report upon performing the measurement based on the L1 measurement configuration. (not shown).

At step 520, The gNB or base station of Cell A decides to execute LTM cell switch to a target cell B and transmits an LTM cell switch command MAC CE (or DCI) to the UE triggering an LTM cell switch to target Cell B.

The LTM cell switch command MAC CE (or DCI) includes the candidate configuration index of the target cell (i.e., Cell B). At step 510, the UE may receive an LTM configuration of multiple candidate cells, and each configuration is identified by a candidate configuration index. The LTM cell switch command MAC CE (or DCI) does not include TA. The LTM cell switch command MAC CE (or DCI) includes a field ‘C’ set to 1. The length of the C field is 1 bit. The C field indicates the presence of contention-free Random Access Resources fields. If the value of the C field is set to 1, the following fields are present, including Random Access Preamble index field, S/U field, SS/PBCH index field and PRACH Mask index field. The LTM cell switch command MAC CE (or DCI) includes a field ‘S/U’ which indicates which UL carrier to transmit the PRACH of the contention-free Random-Access Resources. If the value of the S/U field is set to 1, the SUL carrier is used. Otherwise, the NUL carrier is used. The length of the S/U field is 1 bit. The LTM cell switch command MAC CE (or DCI) includes a Random-Access Preamble index field which indicates the Random-Access Preamble index of the contention-free Random-Access Resources. The length of the Random-Access Preamble index field is 6 bits. The LTM cell switch command MAC CE (or DCI) includes an SS/PBCH index field which indicates the SS/PBCH that shall be used to determine the RACH occasion for the PRACH transmission of the contention-free Random-Access Resources. The LTM cell switch command MAC CE (or DCI) include a PRACH Mask index.

At step 530, the TA of target cell B is not available (i.e., the UE has not received TA in the switching command and the UE has not estimated the TA itself), and the UE initiates a random access procedure towards target cell B.

At step 540, the UE selects the UL carrier indicated by the S/U field in the LTM cell switch command MAC CE (or DCI).

At step 550, the UE selects the SSB indicated by the field SS/PBCH index in the LTM cell switch command MAC CE (or DCI).

At step 560, the UE selects the preamble indicated by the field Random Access Preamble index in the LTM cell switch command MAC CE (or DCI).

At step 570, the UE selects a RACH occasion as follows:

If a rach-ConfigDedicated IE for the UL carrier (indicated by the S/U field in the LTM cell switch command MAC CE [or DCI]) is configured for target cell B in the configuration of target cell B received in step 510, and the rach-ConfigDedicated IE includes a rach-ConfigGeneric IE, the procedure proceeds to step 580. Otherwise (i.e., if a rach-ConfigDedicated IE for the UL carrier [indicated by the S/U field in the Cell Switch Command] configured for target cell B in the configuration of target cell B is not received in step 510 OR if the rach-ConfigDedicated IE for the UL carrier [indicated by S/U field in the Cell Switch Command] is configured for target cell B in the configuration of target cell B received in step 510, but the rach-ConfigDedicated IE does not include a rach-ConfigGeneric IE), the procedure proceeds to step 590.

At step 580, the UE applies the PRACH Mask index received in the LTM cell switch command MAC CE (or DCI) to RACH occasion(s) configured by the rach-ConfigGeneric IE in the rach-ConfigDedicated IE (i.e., rach-ConfigDedicated→rach-ConfigGeneric→prach-ConfigurationIndex), to determine the RACH occasion(s) for the PRACH transmission, where rach-ConfigDedicated is the rach-ConfigDedicated IE for the UL carrier (the UL carrier indicated by the S/U field in the LTM cell switch command MAC CE [or DCI]) in the configuration of target cell B.

For step 580, RACH occasion(s) configured by the rach-ConfigGeneric IE refers to RACH occasion(s) indicated by the field prach-ConfigurationIndex in the rach-ConfigGeneric IE in the rach-ConfigDedicated IE, where the rach-ConfigDedicated IE is the rach-ConfigDedicated IE for the UL carrier (the UL carrier indicated by the S/U field in the LTM cell switch command MAC CE [or DCI]) in the configuration of target cell B. Amongst these RACH occasions, the UE will select a RACH occasion associated the selected SSB based on the PRACH Mask index. The UE first determines RACH occasions associated with the selected SSB association of RACH occasions to SSBs transmitted in cell is as explained above herein. Amongst these RACH occasions associated with the selected SSB, the UE selects the RACH occasion which is allowed based on the PRACH mask index. If the PRACH mask index is 1, all RACH occasions associated with the selected SSB are allowed, and the UE can select the next available PRACH occasion from the PRACH occasions corresponding to the selected SSB. If the PRACH mask index is i (where i=2, 3, 4 5, 6, 7, 8), the ith RACH occasion amongst the RACH occasions associated with the selected SSB are allowed. If the PRACH mask index is 9, even numbered RACH occasions associated with the selected SSB are allowed. If the PRACH mask index is 10, odd numbered RACH occasions associated with the selected SSB are allowed.

At step 590, the UE applies the PRACH Mask index to RACH occasion(s) configured by the rach-ConfigCommon IE (i.e., by rach-ConfigCommon→rach-ConfigGeneric→prach-ConfigurationIndex) in the selected carrier's UL BWP configuration of a BWP indicated by firstActive UplinkBWP-Id, to determine the RACH occasion(s) for the PRACH transmission. firstActive UplinkBWP-Id and the UL BWP configuration are received in the configuration of target cell B received in step 510.

For step 590, RACH occasion(s) configured by the rach-ConfigGeneric IE means RACH occasion(s) indicated by the field prach-ConfigurationIndex in the rach-ConfigGeneric IE. Amongst these RACH occasions, the UE will select a RACH occasion associated the selected SSB based on the PRACH Mask index. The UE first determines RACH occasions associated with the selected SSB. Amongst these RACH occasions associated with the selected SSB, the UE selects the RACH occasion which is allowed based on the PRACH mask index. If the PRACH mask index is 1, all RACH occasions associated with the selected SSB are allowed, and the. UE can select the next available PRACH occasion from the PRACH occasions corresponding to the selected SSB. If The PRACH mask index is i (where i=2, 3, 4 5, 6, 7, 8), the ith RACH occasion amongst the RACH occasions associated with the selected SSB are allowed. If the PRACH mask index is 9, even numbered RACH occasions associated with the selected SSB are allowed. If the PRACH mask index is 10, odd numbered RACH occasions associated with selected SSB are allowed.

Note that for step 590, there can be several rach-ConfigCommon IEs in the UL BWP configuration of a UL carrier, each associated with a different feature/feature combination. For example, the feature can be SDT, redcap, slicing, Msg3 repetitions, Msg1 repetitions etc. For step 590, the rach-ConfigCommon IE is the rach-ConfigCommon IE which is not associated with any feature/feature combination if the UE is not a redcap UE. For a redcap UE, the rach-ConfigCommon IE is the rach-ConfigCommon IE which is associated with redcap only or the rach-ConfigCommon IE is the rach-ConfigCommon IE which is not associated with any feature/feature combination if there is no rach-ConfigCommon associated with redcap only.

After the UE selects a RACH occasion, the UE transmits the selected preamble in the selected RACH occasion to the target cell. (not shown). The UE then receives an UL grant from the target cell. (not shown). In the UL grant, the UE transmits a RRCReconfigurationComplete message. (not shown).

In some embodiments, if the rach-ConfigDedicated IE for the UL carrier (indicated by the S/U field in the Cell Switch Command) includes an ra-Prioritization configuration and the Cell Switch Command indicates contention-free Random Access Resources fields, the UE applies parameters (backoff scaling factor, power ramping step) configured by the ra-Prioritization configuration during the RACH based LTM Cell switch.

Although FIG. 5 illustrates one example procedure for lower layer triggered mobility 500, various changes may be made to FIG. 5. For example, while shown as a series of steps, various steps in FIG. 5 could overlap, occur in parallel, occur in a different order, occur any number of times, be omitted, or replaced by other steps.

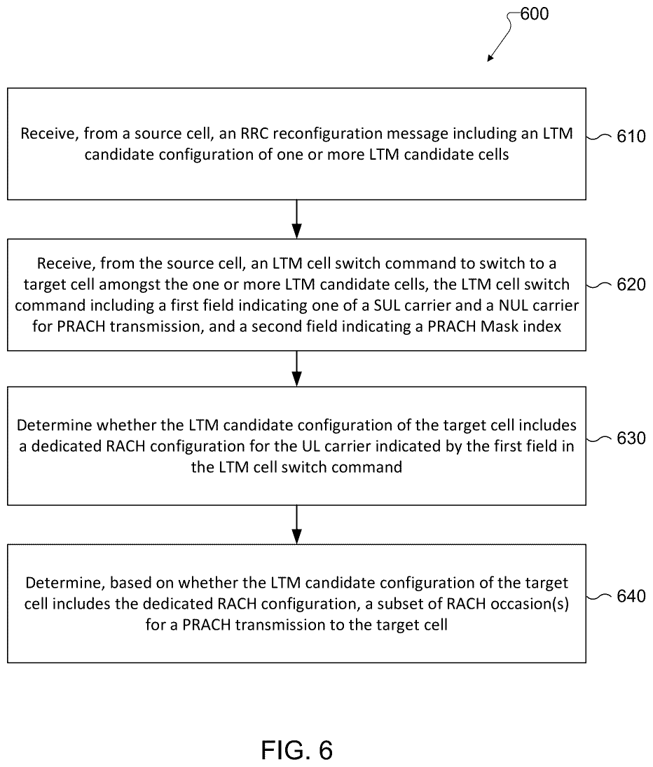

FIG. 6 illustrates an example method for RA based LTM 600 according to embodiments of the present disclosure. An embodiment of the method illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments a method for RA based LTM could be used without departing from the scope of this disclosure.

In the example of FIG. 6, method 600 begins at step 610. At step 610, a UE (such as UE 116 of FIG. 1) receives, from a source cell, an RRC reconfiguration message including an LTM candidate configuration of one or more LTM candidate cells.

At step 620, the UE receives, from the source cell, an LTM cell switch command to switch to a target cell amongst the one or more LTM candidate cells. The LTM cell switch command includes a first field (e.g., an S/U field) indicating one of a SUL carrier and a NUL carrier for PRACH transmission, and a second field (e.g., a PRACH Mask index field) indicating a PRACH Mask index. The LTM switch command may be one of a MAC CE or DCI.

At step 630, the UE determines whether the LTM candidate configuration of the target cell includes a dedicated RACH configuration (e.g., a rach-ConfigDedicated IE) for the UL carrier indicated by the first field in the LTM cell switch command.

At step 640, the UE determines, based on whether the LTM candidate configuration of the target cell includes the dedicated RACH configuration, a subset of RACH occasion(s) for a PRACH transmission to the target cell.

In some embodiments, the LTM candidate configuration of the target cell includes a dedicated RACH configuration (e.g., a rach-ConfigDedicated IE) for the UL carrier indicated by the first field in LTM cell switch command, and the dedicated RACH configuration includes a generic RACH configuration information element (e.g., rach-ConfigGeneric) that includes a configuration of RACH occasion(s). In these embodiments, to determine the subset of RACH occasion(s) for the PRACH transmission to the target cell, the UE applies the PRACH mask index indicated by the second field in the LTM cell switch command to the RACH occasion(s) configured by the generic RACH configuration information element.

In some embodiments, the LTM candidate configuration of the target cell does not include a dedicated RACH configuration (e.g., a rach-ConfigDedicated IE) for the UL carrier indicated by the first field in LTM cell switch command. In these embodiments, to determine the subset of RACH occasion(s) for the PRACH transmission to the target cell, the UE applies the PRACH mask index indicated by the second field in the LTM cell switch command to RACH occasion(s) configured by a common RACH configuration (e.g. a rach-ConfigCommon IE) in a BWP configuration of the UL carrier indicated by the first field in the LTM cell switch command. The BWP configuration is received in the LTM candidate configuration of the target cell, and the BWP configuration is for a BWP indicated by a parameter firstActive UplinkBWP-Id.

In some embodiments, the LTM candidate configuration of the target cell includes a dedicated RACH configuration (e.g., a rach-ConfigDedicated IE) for the UL carrier indicated by the first field in LTM cell switch command, and the dedicated RACH configuration does not include a generic RACH configuration information element (e.g., rach-ConfigGeneric) that includes a configuration of RACH occasion(s). In these embodiments, to determine the subset of RACH occasion(s) for the PRACH transmission to the target cell, the UE applies the PRACH mask index indicated by the second field in the LTM cell switch command to RACH occasion(s) configured by a common RACH configuration (e.g. a rach-ConfigCommon IE) in a BWP configuration of the UL carrier indicated by the first field in the LTM cell switch command. The BWP configuration is received in the LTM candidate configuration of the target cell, and the BWP configuration is for a BWP indicated by a parameter firstActive UplinkBWP-Id.

Although FIG. 6 illustrates one example method for RA based LTM 600, various changes may be made to FIG. 6. For example, while shown as a series of steps, various steps in FIG. 6 could overlap, occur in parallel, occur in a different order, occur any number of times, be omitted, or replaced by other steps.

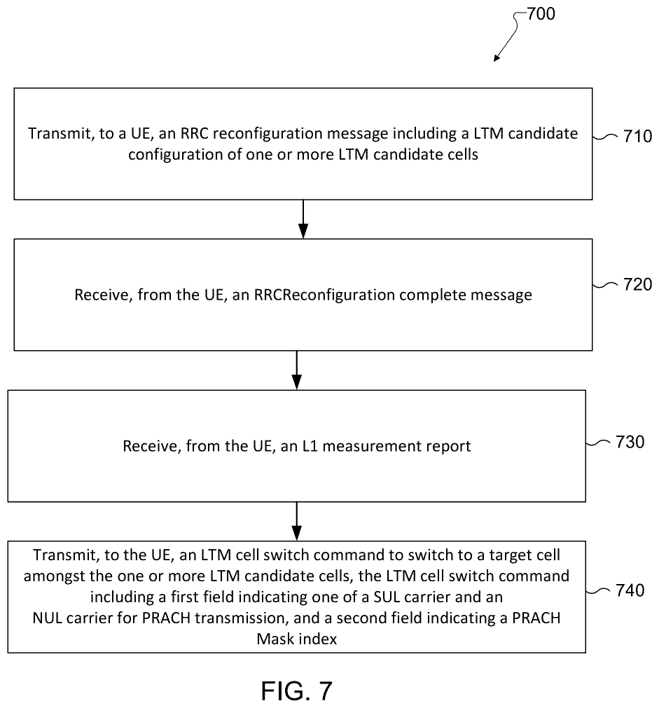

FIG. 7 illustrates another example method for RA based LTM 700 according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. Other embodiments a method for RA based LTM could be used without departing from the scope of this disclosure.

In the example of FIG. 7, method 700 begins at step 710. At step 710, a BS (such as BS 102 of FIG. 1) transmits, to a UE (such as UE 116 of FIG. 1), an RRC reconfiguration message including an LTM candidate configuration of one or more LTM candidate cells. In some embodiments the LTM candidate configuration may include an L1 measurement configuration.

At step 720, the BS receives a RRCReconfiguration complete message from the UE which confirms the RRC Reconfiguration.

At step 730, the BS receives an L1 measurement report from the UE. In response to the measurement report, the BS determines to initiate an LTM cell switch for the UE.

At step 740, the BS transmits, to the UE, an LTM cell switch command to switch to a target cell amongst the one or more LTM candidate cells. The LTM cell switch command includes a first field (e.g., an S/U field) indicating one of an SUL carrier and an NUL carrier for PRACH transmission, and a second field (e.g., a PRACH Mask index field) indicating a PRACH Mask index. The cell switch command may be one of a MAC CE or DCI.

In some embodiments, the UE is configured to determine whether the LTM candidate configuration of the target cell includes a dedicated RACH configuration (e.g., a rach-ConfigDedicated IE) for the UL carrier indicated by the first field in the LTM cell switch command, and determine, based on whether the LTM candidate configuration of the target cell includes the dedicated RACH configuration, a subset of RACH occasion(s) for a PRACH transmission to the target cell.

In some embodiments, the LTM candidate configuration of the target cell includes a dedicated RACH configuration (e.g., a rach-ConfigDedicated IE) for the UL carrier indicated by the first field in LTM cell switch command, and the dedicated RACH configuration includes a generic RACH configuration information element (e.g., rach-ConfigGeneric) that includes a configuration of RACH occasion(s). In these embodiments, the UE may be configured to determine the subset of RACH occasion(s) for the PRACH transmission to the target cell by applying the PRACH mask index indicated by the second field in the LTM cell switch command to the RACH occasion(s) configured by the generic RACH configuration information element.

In some embodiments, the LTM candidate configuration of the target cell may include a BWP configuration of the UL carrier indicated by the first field in the LTM cell switch command for a BWP indicated by a parameter firstActive UplinkBWP-Id.

In some embodiments, the LTM candidate configuration of the target cell does not include a dedicated RACH configuration (e.g., a rach-ConfigDedicated IE) for the UL carrier indicated by the first field in LTM cell switch command. In these embodiments, the UE may be configured to determine the subset of RACH occasion(s) for the PRACH transmission to the target cell by applying the PRACH mask index indicated by the second field in the LTM cell switch command to RACH occasion(s) configured by a common RACH configuration (e.g. a rach-ConfigCommon IE) in the BWP configuration.

In some embodiments, the LTM candidate configuration of the target cell includes a dedicated RACH configuration (e.g., a rach-ConfigDedicated IE) for UL carrier indicated by the first field in LTM cell switch command, and the dedicated RACH configuration does not include a generic RACH configuration information element (e.g., rach-ConfigGeneric) that includes a configuration of random access channel (RACH) occasion(s). In these embodiments, the UE may be configured to determine the subset of RACH occasion(s) for the PRACH transmission to the target cell by applying the PRACH mask index indicated by the second field in the LTM cell switch command to RACH occasion(s) configured by a common RACH configuration (e.g. a rach-ConfigCommon IE) in the BWP configuration.

Although FIG. 7 illustrates one example method for RA based LTM 700, various changes may be made to FIG. 7. For example, while shown as a series of steps, various steps in FIG. 7 could overlap, occur in parallel, occur in a different order, occur any number of times, be omitted, or replaced by other steps.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A user equipment (UE) comprising:
a transceiver configured to:
receive, from a source cell, a radio resource control (RRC) reconfiguration message including a lower layer triggered mobility (LTM) candidate configuration of one or more LTM candidate cells; and
receive, from the source cell, an LTM cell switch command to switch to a target cell amongst the one or more LTM candidate cells, the LTM cell switch command including a first field indicating one of a supplementary uplink (SUL) carrier and a normal uplink (NUL) carrier for physical random access channel (PRACH) transmission, and a second field indicating a PRACH Mask index; and
a processor operatively coupled to the transceiver, the processor configured to:
determine whether the LTM candidate configuration of the target cell includes a dedicated random access channel (RACH) configuration for the uplink (UL) carrier indicated by the first field in the LTM cell switch command; and
determine, based on whether the LTM candidate configuration of the target cell includes the dedicated RACH configuration, a subset of RACH occasion(s) for a PRACH transmission to the target cell.

2. The UE of claim 1, wherein:
the LTM candidate configuration of the target cell includes a dedicated RACH configuration for the UL carrier indicated by the first field in LTM cell switch command;
the dedicated RACH configuration includes a generic RACH configuration information element that includes a configuration of RACH occasion(s); and
to determine the subset of RACH occasion(s) for the PRACH transmission to the target cell, the processor is configured to apply the PRACH mask index indicated by the second field in the LTM cell switch command to the RACH occasion(s) configured by the generic RACH configuration information element.

3. The UE of claim 1, wherein:
the LTM candidate configuration of the target cell does not include a dedicated RACH configuration for the UL carrier indicated by the first field in LTM cell switch command; and
to determine the subset of RACH occasion(s) for the PRACH transmission to the target cell, the processor is configured to apply the PRACH mask index indicated by the second field in the LTM cell switch command to RACH occasion(s) configured by a common RACH configuration in a bandwidth part (BWP) configuration of the UL carrier indicated by the first field in the LTM cell switch command.

4. The UE of claim 3, wherein the BWP configuration is received in the LTM candidate configuration of the target cell, and the BWP configuration is for a BWP indicated by a parameter firstActive UplinkBWP-Id.

5. The UE of claim 1, wherein:
the LTM candidate configuration of the target cell includes a dedicated RACH configuration for the uplink (UL) carrier indicated by the first field in LTM cell switch command;
the dedicated RACH configuration does not include a generic RACH configuration information element that includes a configuration of random access channel (RACH) occasion(s); and
to determine RACH occasion(s) for a PRACH transmission to the target cell, the processor is configured to apply the PRACH mask index indicated by the second field in the LTM cell switch command to RACH occasion(s) configured by a common RACH configuration in a bandwidth part (BWP) configuration of the UL carrier indicated by the first field in the LTM cell switch command.

6. The UE of claim 5, wherein the BWP configuration is received in the LTM candidate configuration of the target cell, and the BWP configuration is for a BWP indicated by a parameter firstActive UplinkBWP-Id.

7. The UE of claim 1, wherein the LTM cell switch command is one of:
a medium access control (MAC) control element (CE); or
downlink control information (DCI).

8. A base station (BS) comprising:
a processor; and
a transceiver operatively coupled to the processor, the transceiver configured to:
transmit, to a user equipment (UE), a radio resource control (RRC) reconfiguration message including a lower layer triggered mobility (LTM) candidate configuration of one or more LTM candidate cells; and
transmit, to the UE, an LTM cell switch command to switch to a target cell amongst the one or more LTM candidate cells, the LTM cell switch command including a first field indicating one of a supplementary uplink (SUL) carrier and a normal uplink (NUL) carrier for physical random access channel (PRACH) transmission, and a second field indicating a PRACH Mask index.

9. The BS of claim 8, wherein:
the LTM candidate configuration of the target cell includes a dedicated RACH configuration for the UL carrier indicated by the first field in LTM cell switch command;
the dedicated RACH configuration includes a generic RACH configuration information element that includes a configuration of RACH occasion(s); and
the UE is configured to determine a subset of RACH occasion(s) for a PRACH transmission to the target cell by applying the PRACH mask index indicated by the second field in the LTM cell switch command to the RACH occasion(s) configured by the generic RACH configuration information element.

10. The BS of claim 8, wherein the LTM candidate configuration of the target cell includes a bandwidth part (BWP) configuration of the UL carrier indicated by the first field in the LTM cell switch command for a BWP indicated by a parameter firstActive UplinkBWP-Id.

11. The BS of claim 10, wherein the LTM candidate configuration of the target cell does not include a dedicated RACH configuration for the UL carrier indicated by the first field in LTM cell switch command; and
the UE is configured to determine a subset of RACH occasion(s) for a PRACH transmission to the target cell by applying the PRACH mask index indicated by the second field in the LTM cell switch command to RACH occasion(s) configured by a common RACH configuration in the BWP configuration.

12. The BS of claim 10, wherein the LTM candidate configuration of the target cell includes a dedicated RACH configuration for the uplink (UL) carrier indicated by the first field in LTM cell switch command;
the dedicated RACH configuration does not include a generic RACH configuration information element that includes a configuration of random access channel (RACH) occasion(s); and
the UE is configured to determine a subset of RACH occasion(s) for a PRACH transmission to the target cell by applying the PRACH mask index indicated by the second field in the LTM cell switch command to RACH occasion(s) configured by a common RACH configuration in the BWP configuration.

13. The BS of claim 8, wherein the LTM cell switch command is one of:
a medium access control (MAC) control element (CE); or
downlink control information (DCI).

14. A method of operating a user equipment (UE), the method comprising:
receiving, from a source cell, a radio resource control (RRC) reconfiguration message including a lower layer triggered mobility (LTM) candidate configuration of one or more LTM candidate cells;
receiving, from the source cell, an LTM cell switch command to switch to a target cell amongst the one or more LTM candidate cells, the LTM cell switch command including a first field indicating one of a supplementary uplink (SUL) carrier and a normal uplink (NUL) carrier for physical random access channel (PRACH) transmission, and a second field indicating a PRACH Mask index;
determining whether the LTM candidate configuration of the target cell includes a dedicated random access channel (RACH) configuration for the uplink (UL) carrier indicated by the first field in the LTM cell switch command; and
determining, based on whether the LTM candidate configuration of the target cell includes the dedicated RACH configuration, a subset of RACH occasion(s) for a PRACH transmission to the target cell.

15. The method of claim 14, wherein:
the LTM candidate configuration of the target cell includes a dedicated RACH configuration for the UL carrier indicated by the first field in LTM cell switch command;
the dedicated RACH configuration includes a generic RACH configuration information element that includes a configuration of RACH occasion(s); and
to determine the subset of RACH occasion(s) for the PRACH transmission to the target cell, the method further comprises applying the PRACH mask index indicated by the second field in the LTM cell switch command to the RACH occasion(s) configured by the generic RACH configuration information element.

16. The method of claim 14, wherein:
the LTM candidate configuration of the target cell does not include a dedicated RACH configuration for the UL carrier indicated by the first field in LTM cell switch command; and
to determine the subset of RACH occasion(s) for the PRACH transmission to the target cell, the method further comprises applying the PRACH mask index indicated by the second field in the LTM cell switch command to RACH occasion(s) configured by a common RACH configuration in a bandwidth part (BWP) configuration of the UL carrier indicated by the first field in the LTM cell switch command.

17. The method of claim 16, wherein the BWP configuration is received in the LTM candidate configuration of the target cell, and the BWP configuration is for a BWP indicated by a parameter firstActiveUplinkBWP-Id.

18. The method of claim 14, wherein:
the LTM candidate configuration of the target cell includes a dedicated RACH configuration for the uplink (UL) carrier indicated by the first field in LTM cell switch command;
the dedicated RACH configuration does not include a generic RACH configuration information element that includes a configuration of random access channel (RACH) occasion(s); and
to determine the subset of RACH occasion(s) for the PRACH transmission to the target cell, the method further comprises applying the PRACH mask index indicated by the second field in the LTM cell switch command to RACH occasion(s) configured by a common RACH configuration in a bandwidth part (BWP) configuration of the UL carrier indicated by the first field in the LTM cell switch command.

19. The method of claim 18, wherein the BWP configuration is received in the LTM candidate configuration of the target cell, and the BWP configuration is for a BWP indicated by a parameter firstActive UplinkBWP-Id.

20. The method of claim 14, wherein the LTM cell switch command is one of:
a medium access control (MAC) control element (CE); or
downlink control information (DCI).
